(19) United States
(12) Patent Application Publication
(10) Pub. No.: US 2021/0065059 A1
(43) Pub. Date: Mar. 4, 2021

(54) MONITORING COMPUTING SYSTEM STATUS BY IMPLEMENTING A DEEP UNSUPERVISED BINARY CODING NETWORK

(71) Applicant: NEC Laboratories America, Inc., Princeton, NJ (US)

(72) Inventors: Dongjin Song, Princeton, NJ (US); Yuncong Chen, Plainsboro, NJ (US); Cristian Lumezanu, Princeton Junction, NJ (US); Takehiko Mizoguchi, Princeton, NJ (US); Haifeng Chen, West Windsor, NJ (US); Dixian Zhu, Iowa City, IA (US)

(21) Appl. No.: 17/002,960

(22) Filed: Aug. 26, 2020

Related U.S. Application Data
(60) Provisional application No. 62/892,039, filed on Aug. 27, 2019.
(60) Provisional application No. 62/895,549, filed on Sep. 4, 2019.

(51) Int. Cl. G06N 20/00; G06F 11/30; G06F 11/34

(52) U.S. Cl. CPC G06N 20/00; G06F 11/3495; G06F 11/3055; G06F 11/3013

(57) ABSTRACT

A computer-implemented method for monitoring computing system status by implementing a deep unsupervised binary coding network includes receiving multivariate time series data from one or more sensors associated with a system, implementing a long short-term memory (LSTM) encoder-decoder framework to capture temporal information of different time steps within the multivariate time series data and perform binary coding, the LSTM encoder-decoder framework including a temporal encoding mechanism, a clustering loss and an adversarial loss, computing a minimal distance from the binary code to historical data, and obtaining a status determination of the system based on a similar pattern analysis using the minimal distance.

### RELATED APPLICATION INFORMATION

This application claims priority to provisional application Ser. Nos. 62/892,039, filed on Aug. 27, 2019, and 62/895,549, filed on Sep. 4, 2019, incorporated herein by reference herein in their entirety.

### BACKGROUND

### Technical Field

The present invention relates to artificial intelligence and machine learning, and more particularly to monitoring computing system status by implementing a deep unsupervised binary coding network.

### Description of the Related Art

Multivariate time series data is becoming increasingly ubiquitous in various real-world applications such as, e.g., smart city systems, power plant monitoring systems, wearable devices, etc. Given historical multivariate time series data (e.g., sensor readings of a power plant system) without any status label before time T and a current multivariate time series segment, it can be challenging to retrieve similar patterns in the historical data in an efficient manner and use these similar patterns to interpret the status of current segment. For example, it can be difficult to obtain compact representations of the historical multivariate time series data, employ the hidden structure and temporal information of the raw time series data to generate a representation and/or generate a representation with better generalization capability.

Unsupervised hashing can be categorized in a plurality of types, including randomized hashing (e.g., Locality Sensitive Hashing (LSH)), unsupervised methods which consider data distribution (e.g., Spectral Hashing (SH) and Iterative Quantization (ITQ), and deep unsupervised hashing approaches which employ deep learning to obtain a meaningful representation of the input (e.g., DeepBit and DeepHash). However, these methods are limited at least because: (1) they cannot capture the underlying clustering/structural information of the input data; (2) they do not consider the temporal information of the input data; and (3) they do not focus on producing a representation with better generalization capability.

### SUMMARY

According to an aspect of the present invention, a method for monitoring computing system status by implementing a deep unsupervised binary coding network is provided. The method includes receiving multivariate time series data from one or more sensors associated with a system, and implementing a long short-term memory (LSTM) encoder-decoder framework to capture temporal information of different time steps within the multivariate time series data and perform binary coding. The LSTM encoder-decoder framework includes a temporal encoding mechanism, a clustering loss and an adversarial loss. Implementing the LSTM encoder-decoder framework further includes generating one or more time series segments based on the multivariate time series data using an LSTM encoder to perform temporal encoding, and generating binary code for each of the one or more time series segments based on a feature vector. The method further includes computing a minimal distance from the binary code to historical data, and obtaining a status determination of the system based on a similar pattern analysis using the minimal distance.

According to another aspect of the present invention, a system for monitoring computing system status by implementing a deep unsupervised binary coding network is provided. The system includes a memory device storing program code, and at least one processor device operatively coupled to the memory device. The at least one processor device is configured to execute program code stored on the memory device to receive multivariate time series data from one or more sensors associated with a system, and implement a long short-term memory (LSTM) encoder-decoder framework to capture temporal information of different time steps within the multivariate time series data and perform binary coding. The LSTM encoder-decoder framework includes a temporal encoding mechanism, a clustering loss and an adversarial loss. The at least one processor device is further configured to implement the LSTM encoder-decoder framework by generating one or more time series segments based on the multivariate time series data using an LSTM encoder to perform temporal encoding, and generating binary code for each of the one or more time series segments based on a feature vector. The at least one processor device is configured to execute program code stored on the memory device to compute a minimal distance from the binary code to historical data, and obtain a status determination of the system based on a similar pattern analysis using the minimal distance.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level overview of a framework including a system for monitoring computing system status by implementing a deep unsupervised binary coding network, in accordance with an embodiment of the present invention;

FIG. 2 is a block/flow diagram illustrating a deep unsupervised binary coding framework, in accordance with an embodiment of the present invention;

FIG. 3 is a diagram illustrating temporal dependency modeling via temporal encoding on hidden features, in accordance with an embodiment of the present invention;

FIG. 4 is a block/flow diagram illustrating a system/method for monitoring computing system status by implementing a deep unsupervised binary coding network, in accordance with an embodiment of the present invention; and

FIG. 5 is a block/flow diagram illustrating a computer system, in accordance with an embodiment the present invention.

### DETAILED DESCRIPTION OF PREFERRED EMBODIMENTS

In accordance with embodiments of the present invention, systems and methods are provided to implement an end-to-end deep supervised binary coding (e.g., hashing) framework for multivariate time series retrieval. The framework described herein can be used to obtain compact representations of the historical multivariate time series data, employ the hidden structure and temporal information of the raw time series data to generate a representation and/or generate a representation with better generalization capability. More specifically, a long short-term memory (LSTM) Encoder-Decoder framework is provided to capture the essential temporal information of different type steps within the input segment and to learn the binary code based upon reconstruction error. The LSTM Encoder-Decoder framework can: (1) use a clustering loss on the hidden feature space to capture the nonlinear hidden feature structure of the raw input data and enhance the discriminative property of generated binary codes; (2) utilize a temporal encoding mechanism to encode the temporal order of different segments within a mini-batch in order to pay sufficient attention to high similarity consecutive segments; (3) use an adversarial loss to improve the generalization capability of the generated binary codes (e.g., impose a conditional adversarial regularizer based upon conditional General Adversarial Networks (cGANs))

The embodiments described herein can facilitate underlying applications such as system status identification, anomaly detection, etc. within a variety of real-world systems that collect multivariate time series data. Such real-world systems include, but are not limited to smart city systems, power plant monitoring systems, wearable devices, etc. For example, within a power plant monitoring system, a plurality of sensors can be employed to monitor real-time or near real-time operation status. As another example, with a wearable device such as, e.g., a fitness tracking device, a temporal sequence of actions (e.g., walking for 5 minutes, running for 1 hour and sitting for 15 minutes) can be recorded and detected with related sensors.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

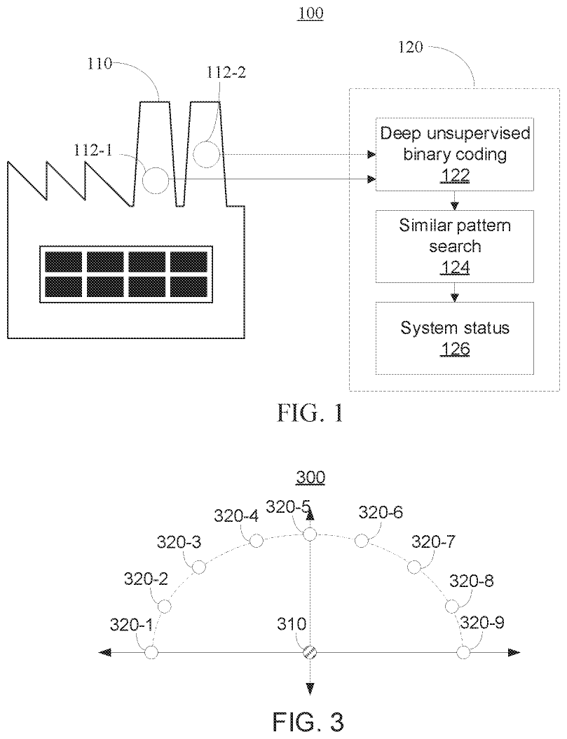

Referring now in detail to the figures in which like numerals represent the same or similar elements and initially to FIG. 1, a high-level overview of a framework 100 for monitoring computing system status by implementing a deep unsupervised binary coding network is depicted in accordance with one embodiment of the present invention.

As shown, the framework 100 includes a system 110. More specifically, the system 110 in this illustrative example is a power plant system 110 having a plurality of sensors, including sensors 112-1 and 112-2, configured to monitor the status of the power plant system 110 and generate multivariate time series data at different time steps. Although the system 110 is a power plant system 110 in this illustrative embodiment, the system 100 can include any suitable system configured to generate multivariate time series data in accordance with the embodiments described herein (e.g., wearable device systems, smart city systems).

As further shown, the framework 100 further includes at least one processing device 120. The processing device 120 is configured to implement a deep unsupervised binary coding network (DUBCN) architecture component 122, a similar pattern search component 124 and a system status component 126. Although the components 122-126 are shown being implemented by a single processing device, one or more of the components 122-126 can be implemented by one or more additional processing devices.

The multivariate time series data generated by the plurality of sensors is received or collected, and input into the DUBCN architecture component 122 to perform multivariate time series retrieval using a DUBCN architecture. More specifically, as will be described in further detail herein below, the DUBCN architecture component 122 is configured to generate one or more time series segments based on the multivariate time series data, and generate binary code (e.g., hash code) for each of the one or more time series segments. The one or more time series segments can be of a fixed window size.

The similar pattern search component 124 is configured to determine if any similar patterns (segments) exists in the historical data based on the one or more binary codes. More specifically, the similar pattern determination component 124 is configured to compute a minimal distance and retrieve any similar patterns in the historical data based on the distance. In one embodiment, the minimal distance is a minimal Hamming distance.

The system status component 126 is configured to determine a current status of the system 110 based on the results of the similar pattern search component 124. For example, if there exists a similar pattern in the historical data, the similar pattern can be used to interpret the current system status. Otherwise, the current system status could correspond to an abnormal or anomalous case.

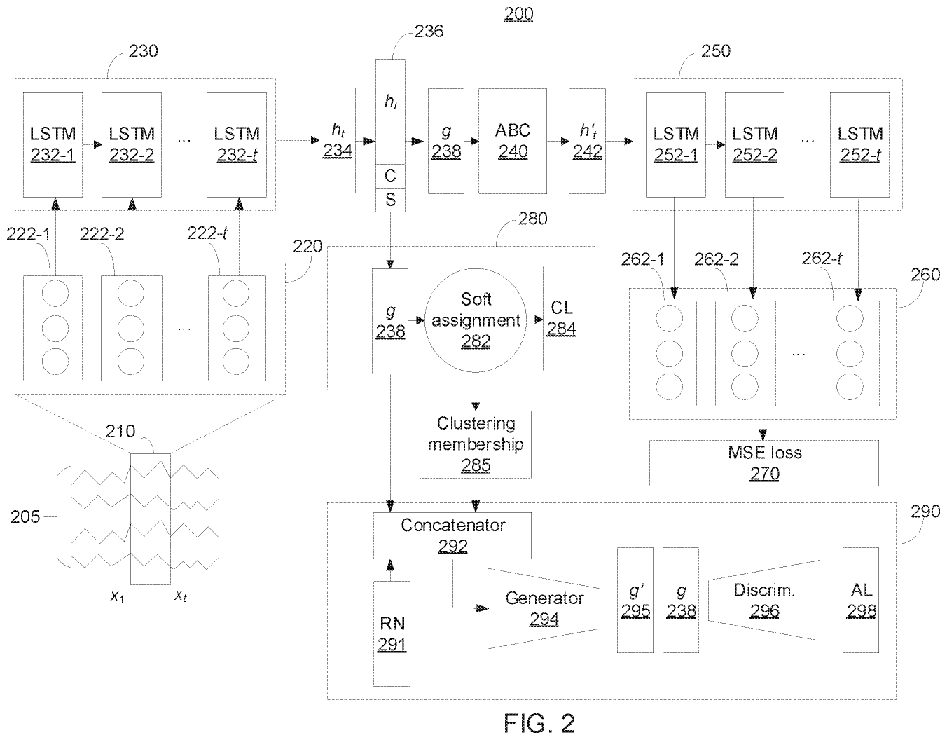

As will be described in further detail below with reference to FIG. 2, the DUBCN architecture component 122 can implement a long short-term memory (LSTM) encoder-decoder framework to capture temporal information of different time steps within the multivariate time series data and perform binary coding. More specifically, the LSTM encoder-decoder framework includes a temporal encoding mechanism to encode the temporal order of different segments within a mini-batch, a clustering loss on the hidden feature space to enhance the nonlinear hidden feature structure, and an adversarial loss based upon conditional General Adversarial Networks (cGANs) to enhance the generalization capability of the generated binary codes.

For example, given a multivariate time series segment \vec{X}_{t,w}=(x¹, . . . , xⁿ)^{T}=(x_{t-w}, . . . , xₜ) ∈ [symbol] ^{n×w} where t is the time step index and w is the length of window size, the k-th time series of length w can be represented by:

\vec{x}^{k}=(x_{t-w}^{k}, x_{t-w+1}^{k}, . . . , xₜ^{k})^{T} ∈ [symbol] ^{w}

and

\vec{x}ₜ=(xₜ¹, xₜ², . . . , xₜⁿ)^{T} ∈ [symbol] ⁿ

denotes a vector of n input series at time t. In addition, ∥⋅∥_{F} denotes the Frobenius norm of matrices and ∥x∥_{H} represents the Hamming norm of vector \vec{x}, which is defined as the number of nonzero entries in \vec{x} (L₀ norm). ∥x∥₁ represents the L₂ norm of the vector \vec{x}, which is defined as the sum of absolute values of the entries in \vec{x}.

With a query multivariate time series segment \vec{X}_{q,w} ∈ [symbol] ^{n×w} (a slice of n time series that lasts w time steps), it is a goal in accordance with the embodiments described herein to find the most similar time series segments in the historical data (or database). For example, we expect to obtain:

$$arg {min}_{{\vec{X}}_{q , w} ∈ D} S ( {\vec{X}}_{q , w} , {\vec{X}}_{p , w} ) \qquad ( 1 )$$

Where D={\vec{X}_{p,w}} is a collection of segments, p denotes the time index for the p-th segment (∀1+w≤p≤T), T denotes the total length of the time series, and S(⋅) represents a similarity measure function.

The LSTM encoder-decoder framework includes an LSTM encoder to represent the input time series segment by encoding the temporal information within a multivariate time series segment. More specifically, given the input sequence \vec{x}^{k} described above, the LSTM encoder can be applied to learn a mapping from \vec{x}ₜ₋₁ to \vec{h}ₜ (at time step t), with:

\vec{h}ₜ=LSTM_{enc}(\vec{h}ₜ₋₁, \vec{x}ₜ) (2)

where \vec{h}ₜ ∈ [symbol] ^{m} is the hidden state of the LSTM encoder at time t, m is the size of the hidden state, and LSTM_{enc} is a LSTM encoder unit. Each LSTM encoder unit has a memory cell with the state \vec{s}ₜ at time t. Access to the memory cell can be controlled by the following three sigmoid gates: forget gate \vec{f}ₜ, input gate \vec{i}ₜ and output gate \vec{o}ₜ. The update of an LSTM encoder unit can be summarized as follows:

\vec{f}ₜ=σ(\vec{W}_{f}[\vec{h}ₜ₋₁; \vec{x}ₜ]+\vec{b}_{f}) (3)

\vec{i}ₜ=σ(\vec{W}ᵢ[\vec{h}ₜ₋₁; \vec{x}ₜ]+\vec{b}ᵢ) (4)

\vec{o}ₜ=σ(\vec{W}ₒ[\vec{h}ₜ₋₁; \vec{x}ₜ]+\vec{b}ₒ) (5)

\vec{s}ₜ\vec{f}ₜ⊗\vec{s}ₜ₋₁+\vec{i}ₜ*tan h(\vec{W}ₛ[\vec{h}ₜ₋₁; \vec{x}ₜ]+\vec{b}ₛ) (6)

\vec{h}ₜ=\vec{o}ₜ⊗tan h(\vec{s}ₜ) (7)

where [\vec{h}ₜ₋₁; \vec{x}ₜ] ∈ [symbol] ^{m+n} is a concatenation of the previous hidden state \vec{h}ₜ₋₁ and the current input \vec{x}ₜ, \vec{W}_{f}, \vec{W}ᵢ, \vec{W}ₒ, \vec{W}ₛ ∈ [symbol] ^{m×(m+n)} and \vec{b}_{f}, \vec{b}ᵢ, \vec{b}ₒ, \vec{b}ₛ ∈ [symbol] ^{m} are parameters to learn, σ is a logistic sigmoid function and ⊗ corresponds to element-wise multiplication or the Hadamard product. The key reason for using the LSTM encoder unit is that the cell state sums activities over time, which can overcome the problem of vanishing gradients and better capture long-term dependencies of time series.

Further details regarding the structure of the LSTM encoder will be described below with reference to FIG. 2.

Although the LSTM encoder models the temporal information within each segment, the temporal order of different segments may not be captured explicitly. Based upon the intuition that two consecutive (or very close) segments are more likely to have similar binary codes, the temporal encoding mechanism mentioned above can explicitly encode temporal order of different segments. More specifically, for each batch of 2N segments, half of the batch can be randomly sampled and the other half can be sequentially sampled. Randomly sampled segments are employed to avoid unstable gradient and enhance generalization capability. For these segments, a two-dimensional (2D) vector of zero entries can be concatenated to the original hidden feature vector \vec{h}ₜ. For sequentially sampled segments, a temporal encoding vector

$$( sin ( \frac{π i}{N} ) , cos ( \frac{π i}{N} ) )$$

can be employed to encode the relative temporal position of different segments, where N≥i≥0. Therefore, for each batch of segments, the temporal encoding vector, (C,S), can be denoted as:

$$( C , S ) = \{ \begin{matrix}( 0 , 0 ) & if the segment is randomly sampled \\ ( sin ( \frac{π i}{N} ) , cos ( \frac{π i}{N} ) ) , & otherwise .\end{matrix} \qquad ( 8 )$$

Accordingly, the temporal encoding vector focuses on capturing the temporal order of different segments, as opposed to encoding the temporal information within a segment.

Further details regarding the temporal encoding mechanism will be described below with reference to FIG. 2. A visual depiction of (C,S) will now be described below with reference to FIG. 3.

Referring now to FIG. 3, a diagram 300 is provided illustrating temporal within-batch encoding for a temporal encoding vector. As shown, the diagram 300 includes at least one point 310 and a plurality of points 320-1 through 320-9. The point 310 represents the temporal encoding vector (0,0) for the randomly sampled half batch, and the plurality of points 320-1 through 320-9 represents temporal encoding vectors (C,S) for the sequentially sampled half batch.

Referring back to FIG. 1, after the temporal encoding, a fully connected layer can be employed to obtain a feature vector \vec{g} ∈ [symbol] ^{m}. Then, the hyperbolic tangent function tan h(⋅) can be used to generate an approximated binary code tan h(\vec{g}). Another fully connected layer can be used to obtain the feature vector \vec{h}′ₜ ∈ [symbol] ^{m} which will serve as input to the LSTM decoder. A more detailed procedure will be described in further detail below with reference to FIG. 2.

Regarding the clustering loss, with the intuition that multivariate time segments may exhibit different properties (such as uptrend, downtrend, etc.), it is rational explore the nonlinear hidden feature structure of the input time series segments and encourage those segments falling into the same cluster to have more similar features than those segments falling into different clusters. In this way, the generated binary code can also preserve the discriminative information among clusters. For this purpose, assuming the initial cluster centroids {\vec{μ}}ⱼ₌₁^{k} are available in the hidden space, a soft assignment between the hidden feature points \vec{g}ᵢ and the cluster centroids can illustratively be computed as:

$${q}_{i j} = \frac{{( 1 + ‖ \vec{{g}_{ι}} - \vec{{μ}_{J}} ‖ / α )}^{- \frac{α + 1}{2}}}{{\sum }_{j = 1}^{k} {( 1 + ‖ \vec{{g}_{ι}} - \vec{{μ}_{J}} ‖ / α )}^{- \frac{α + 1}{2}}} \qquad ( 9 )$$

where \vec{gₗ} ∈ [symbol] ^{m} is the hidden feature obtained after a fully connected layer based upon temporal encoding, α are the degrees of freedom for a t-distribution, and qᵢⱼ represents the probability of assigning segment i to cluster j. In one embodiment, α=1. In practical applications, the initial cluster centroids {\vec{μ}}ⱼ₌₁^{k} can be obtained based upon centroids in the raw space with a k-means algorithm.

A clustering objective, [symbol] _{cluster}, can be adopted based upon KL divergence loss between the soft assignments qᵢ and an auxiliary target distribution as follows:

$${𝓁}_{cluster} = {\sum }_{i = 1}^{N} {\sum }_{j = 1}^{k} {p}_{ij} log \frac{{p}_{ij}}{{q}_{ij}} . \qquad ( 10 )$$

$${p}_{ij} = \frac{{q}_{ij}^{2} / {z}_{j}}{{Σ}_{j ′} {q}_{ij ′}^{2} / {z}_{j ′}} \qquad ( 11 )$$

where zⱼ=Σᵢqᵢⱼ denotes soft cluster counts. Since the target distribution is expected to improve cluster purity, more emphasis can be put on segments assigned with high confidence, and large clusters can be prevented from distorting the hidden feature space.

Further details regarding the clustering loss will be described below with reference to FIG. 2.

Regarding the adversarial loss, when exploring clustering in the hidden feature space of DUBCNs, one potential issue is overfitting due to the training being conductive over the batch level and possible biased sampled segments in each batch. To overcome this issue, adversarial loss, [symbol] _{adv}, can be employed to enhance the generalization capability of DUBCNs as, e.g.:

[symbol]

_{adv}= [symbol] _{\vec{g}˜p}_{_{data(\vec{g})}}[log D(\vec{g})]+ [symbol] _{\vec{z}˜p}_{_{data(\vec{z})}}[log(1−D(G([\vec{g}+\vec{z}; \vec{c}])))] (12)

where [symbol] denotes an expectation, \vec{g}˜p_{data(\vec{g})} denotes a sample \vec{g} drawn from a data distribution p_{data( )}, \vec{z}˜p_{data(\vec{z})} denotes a sample \vec{z} drawn from the data distribution p_{data( )}, G(⋅) denotes a generator configured to generate a feature vector that looks similar to feature vectors from the raw input segments, and D(⋅) denotes a discriminator configured to discriminate or distinguish between the generated samples G(⋅) and the real feature vector \vec{g} ∈ [symbol] ^{m}. The vector \vec{z} is a random noise vector of dimension m, which can be drawn from a normal distribution. Here, instead of using a generator purely based upon \vec{z}, the sum \vec{g}+\vec{z} is used and the clustering membership \vec{c} ∈ [symbol] ^{k} is concatenated to help generalize the hidden features within a specific cluster. More specifically, G(⋅) can include two fully connected layers (each with an output dimension of m), and D(⋅) can also include two fully connected layers (each with an output dimension of m and 1, respectively).

Further details regarding the adversarial loss will be described below with reference to FIG. 2.

The LSTM encoder-decoder framework includes an LSTM decoder. The LSTM decoder can be defined as:

\vec{d}′ₜ=LSTM_{dec}(\vec{d}′ₜ₋₁, \vec{x}′ₜ₋₁) (13)

where \vec{d}′ₜ can be updated as follows:

\vec{f}′ₜ=σ(\vec{W}′_{f}[\vec{d}′ₜ₋₁; \vec{x}′ₜ₋₁]+\vec{b}′_{f}) (14)

\vec{i}′ₜ=σ(\vec{W}′ᵢ[\vec{d}′ₜ₋₁; \vec{x}′ₜ₋₁]+\vec{b}′ᵢ) (15)

\vec{o}′ₜ=σ(\vec{W}′ₒ[\vec{d}′ₜ₋₁; \vec{x}′ₜ₋₁]+\vec{b}′ₒ) (16)

s′ₜ=\vec{f}′ₜ*\vec{s}′ₜ₋₁+\vec{i}′ₜ⊗tan h(\vec{W}′ₛ[\vec{d}′ₜ₋₁; \vec{x}′ₜ₋₁]+\vec{b}′ₛ) (17)

\vec{d}ₜ=\vec{o}′ₜ⊗tan h(\vec{s}′ₜ) (18)

where [\vec{d}′ₜ₋₁; \vec{x}′ₜ₋₁] ∈ [symbol] ^{p+1} is a concatenation of the previous hidden state \vec{d}′ₜ₋₁ and the decoder input \vec{x}′ₜ₋₁, \vec{W}_{f}, \vec{W}ᵢ, \vec{W}ₒ, \vec{W}ₛ ∈ [symbol] ^{m×(m+n)} and \vec{b}_{f}, \vec{b}ᵢ, \vec{b}ₒ, \vec{b}ₛ ∈ [symbol] ^{m} are parameters to learn, σ is a logistic sigmoid function and ⊗ corresponds to element-wise multiplication or the Hadamard product. The feature vector \vec{h}ₜ ∈ [symbol] ^{m} can serve as the context feature vector for the LSTM decoder at time 0 (e.g., \vec{b}′ₒ=\vec{h}ₜ).

The reconstructed input at each time step can illustratively be produced by:

\hat{x}ₜ=\vec{d}′ₜ\vec{W}ₒᵤₜ+\vec{b}ₒᵤₜ (19)

where \vec{W}ₒᵤₜ ∈ [symbol] ^{m×n} and \vec{b}ₒᵤₜ ∈ [symbol] ⁿ. Further details regarding the LSTM decoder will be described below with reference to FIG. 2.

Mean squared error (MSE) loss, [symbol] _{MSE}, can be used as the objective for the LSTM encoder-decoder to encode the temporal information of the input segment. For example:

$${𝓁}_{MSE} = \frac{1}{N} {\sum }_{i = 1}^{N} {‖ {\hat{X}}_{t , w}^{i} - {X}_{t , w}^{i} ‖}_{F}^{2} \qquad ( 20 )$$

where i is the index for a segment and N is the number of segments in a batch. Further details regarding MSE loss are described below with reference to FIG. 2. The full objective of the DUBCN architecture, [symbol] _{DUBCN}, can be obtained as a linear combination of [symbol] _{MSE}, [symbol] _{cluster} and [symbol] _{adv}. For example, [symbol] _{DUBCN} can be calculated as follows:

[symbol]

_{DUBCN}= [symbol] _{MSE}+λ₁ [symbol] _{cluster}+λ₂ [symbol] _{adv}. (21)

where λ₁≥0 and λ₂≥0 are hyperparameters to control the importance of clustering loss and/or adversarial loss. To optimize [symbol] _{DUBCN}, the following illustrative two-player Minimax game can be solved:

G*, D*=arg min_{G} max_{D} [symbol] _{MSE} (G, D)

To optimize the generator G(⋅) and discriminator D(⋅) iteratively. Specifically, when optimizing D(⋅), we only need to focus on the two fully connected layers of D(⋅), while optimizing G(⋅), the network parameters are updated via [symbol] _{MSE} and [symbol] _{adv}.

Referring now to FIG. 2, an exemplary deep unsupervised binary coding network (DUCBN) architecture 200 is illustratively depicted in accordance with an embodiment of the present invention. The architecture 200 can be implemented by the DUBCN architecture component 122 described above with reference to FIG. 1 for monitoring computing system status.

As shown, the architecture 200 includes input data 210. The input data 210 corresponds to a section or slice of multivariate time series data 205. For example, in this illustrative example, the input data 210 corresponds to a section or slice of data (x₁, . . . , xₜ).

The input data is converted into a set of input segments 220. For example, the set of input segments 220 can include an input segment 222-1 corresponding to x₁, an input segment 222-2 corresponding to x₂, . . . and an input segment 222-t corresponding to xₜ.

As further shown, the architecture 200 includes a long short-term memory (LSTM) encoder 230. Each input segment 222-1 through 222-t of the set of input segments 220 is fed into a respective one of a plurality of LSTMs 232-1 through 232-t. Moreover, the input of each of the plurality of LSTMS is fed into the subsequent LSTM. For example, the input of the LSTM 232-1 is fed into the LSTM 232-2, and so on. The output of the LSTM encoder layer 230 is a hidden state, hₜ, 234. Further details regarding the LSTM encoder 220 are described above with reference to FIG. 1.

Temporal encoding is performed based on the hidden state 234 to form a temporal encoding vector 236 employed to encode the relative temporal position of the different segments. More specifically, the temporal encoding vector 236 is a concatenation of a 2-dimensional vector of zero entries (denoted as “C” and “S”) with the hidden state 234. Further details regarding temporal encoding are described above with reference to FIGS. 1 and 3.

After the temporal encoding, a feature vector, g, 238 is obtained. More specifically, a fully connected layer can be employed to obtain the feature vector 238 based on the hidden state 234. Then, an approximated binary code (ABC) 240 is obtained based on the feature vector 238. For example, the ABC 240 can be obtained by applying the hyperbolic tangent function to the feature vector 238 (tan h(g)). Then, a feature vector, h′ₜ, 242 is obtained. More specifically, another fully connected layer can be employed to obtain the feature vector 242 based on the ABC 240. Further details regarding obtaining components 238 through 242 are described above with reference to FIG. 1.

As further shown, the architecture 200 further includes an LSTM decoder 250 including a plurality of LSTMs 252-1 through 252-t. The feature vector 242 serves as input into the LSTM 252-1. Moreover, the input of each of the plurality of LSTMS is fed into the subsequent LSTM. For example, the input of the LSTM 252-1 is fed into the LSTM 252-2, and so on. Further details regarding the LSTM decoder 230 are described above with reference to FIG. 1.

As further shown, the output of the LSTM decoder 230 includes a set of output segments 260 corresponding to reconstructed input. More specifically, the set of output segments 260 can include an input segment 262-1 output by the LSTM 252-1, an output segment 262-2 output by the LSTM 252-2, . . . and an output segment 262-t output by the LSTM 252-t. Then, a mean square error (MSE) loss 270 is obtained for use as the objective/loss for the LSTM Encoder-Decoder based on the set of output segments 260. Further details regarding the set of output segments 260 corresponding to reconstructed input and the MSE loss 270 are described above with reference to FIG. 1.

As further shown, the architecture 280 includes a clustering loss component 280. More specifically, the feature vector 238 is fed into a soft assignment component 282 configured to compute soft assignments between hidden feature points and initial cluster centroids. Then, a clustering loss (CL) 284 is computed based on the soft assignments and an auxiliary target distribution. Further details regarding the clustering loss component 280 are described above with reference to FIG. 1.

As further shown, the architecture 280 includes an adversarial loss component 290 including a concatenator 292, a generator 294, and a discriminator 296.

The soft assignment component 282 is configured to output clustering membership 285, and the concatenator 292 is configured to concatenate the clustering membership 285 with a sum of the feature vector 238 and a random noise vector (RN) 291. RN 291 can be drawn from a normal distribution. Such a concatenation helps to generalize the hidden features within a specific cluster.

The output of the concatenator 292 is fed into the generator 294 to generate a sample feature vector, g′, 295. For example, the generator 294 can include two fully connected layers having output dimension m. The discriminator 296 aims to distinguish between the sample feature vector 295 and the feature vector 238. For example, the discriminator 296 can include two fully connected layers having output dimension 1. An adversarial loss (AL) 298 is computed based on outputs of the generator 294 and the discriminator 296. Further details regarding the adversarial loss component 290 are described above with reference to FIG. 1.

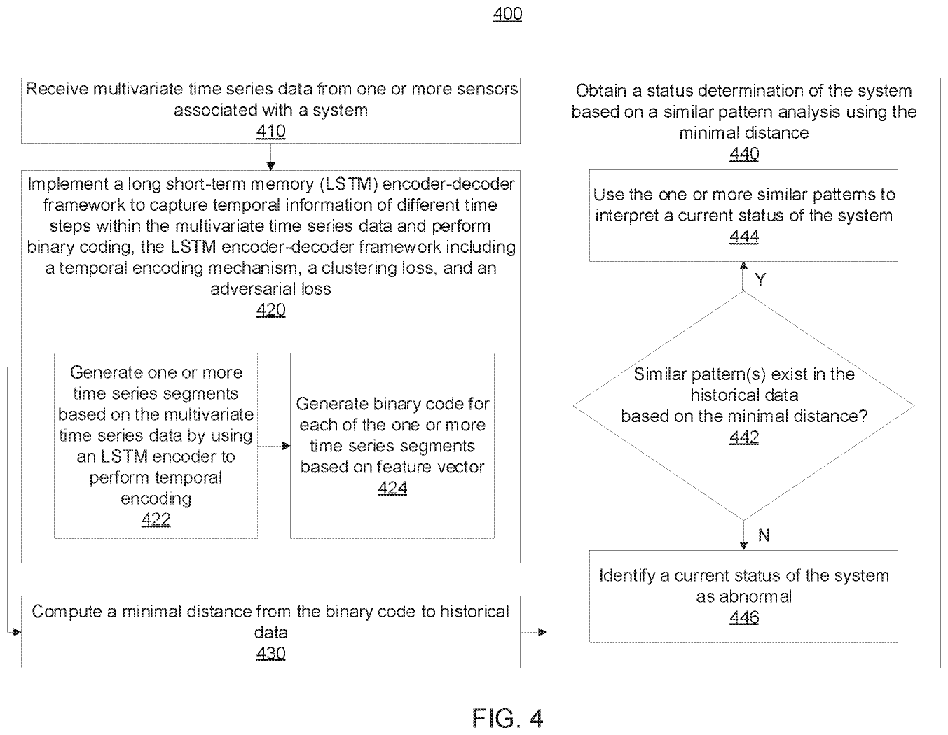

Referring now to FIG. 4, a block/flow diagram is provided illustrating a system/method 400 for monitoring computing system status by implementing a deep unsupervised binary coding network.

At block 410, multivariate time series data is received from one or more sensors associated with a system. The one or more sensors can be associated with any suitable system. For example, the one or more sensors can be associated with a power plant system, a wearable device system, a smart city system, etc.

At block 420, a long short-term memory (LSTM) encoder-decoder framework is implemented to capture temporal information of different time steps within the multivariate time series data and perform binary coding, the LSTM encoder-decoder framework including a temporal encoding mechanism, a clustering loss, and an adversarial loss. The temporal encoding mechanism encodes the temporal order of different segments within a mini-batch, the clustering loss enhances the nonlinear hidden feature structure, and the adversarial loss enhances a generalization capability of binary code generated during the binary coding. The adversarial loss can be based upon conditional General Adversarial Networks (cGANs).

More specifically, at block 422, implementing the LSTM encoder-decoder framework can include generating one or more time series segments based on the multivariate times series data by using an LSTM encoder to perform temporal encoding. The one or more time series segments can be of a fixed window size.

At block 424, implementing the LSTM encoder-decoder framework can further include generating binary code for each of the one or more time series segments based on a feature vector. More specifically, the feature vector can be obtained by employing a fully connected layer, and the binary code can be generated by applying the hyperbolic tangent function to the feature vector. In one embodiment, the binary code includes hash code.

At block 430, a minimal distance from the binary code to historical data is computed. In one embodiment, the minimal distance is a minimal Hamming distance.

At block 440, a status determination of the system is obtained based on a similar pattern analysis using the minimal distance.

For example, at block 442, obtaining the status determination of the system can include determining if any similar patterns exist in the historical data based on the minimal distance.

If it is determined that one or more similar patterns exist in the historical data at block 442, the one or more similar patterns can be used to interpret a current status of the system at block 444. Otherwise, at block 446, a current status of the system is identified as abnormal.

Further details regarding block 410-446 are described above with reference to FIGS. 1-3.

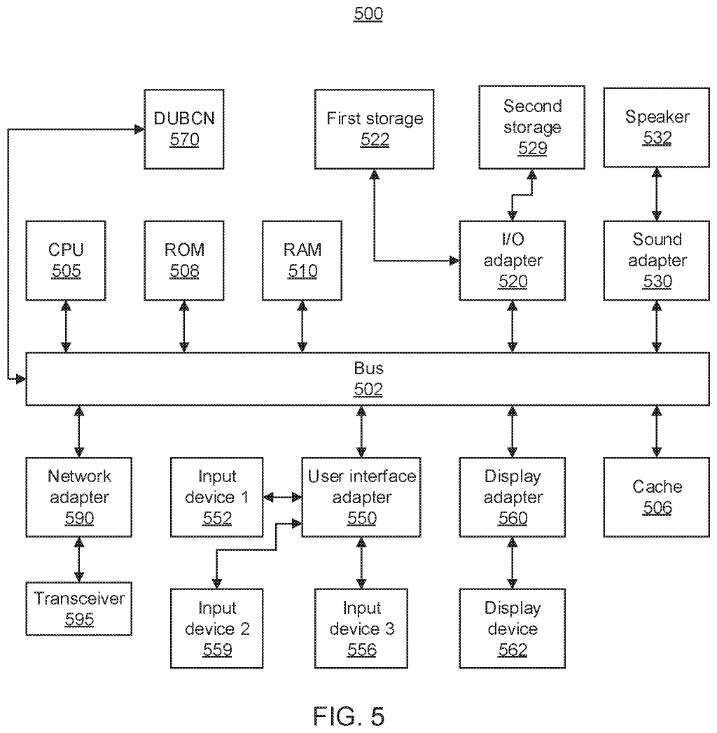

Referring now to FIG. 5, an exemplary computer system 500 is shown which may represent a server or a network device, in accordance with an embodiment of the present invention. The computer system 500 includes at least one processor (CPU) 505 operatively coupled to other components via a system bus 502. A cache 506, a Read Only Memory (ROM) 508, a Random-Access Memory (RAM) 510, an input/output (I/O) adapter 520, a sound adapter 530, a network adapter 590, a user interface adapter 550, and a display adapter 560, are operatively coupled to the system bus 502.

A first storage device 522 and a second storage device 529 are operatively coupled to system bus 502 by the I/O adapter 520. The storage devices 522 and 529 can be any of a disk storage device (e.g., a magnetic or optical disk storage device), a solid state magnetic device, and so forth. The storage devices 522 and 529 can be the same type of storage device or different types of storage devices.

A speaker 532 may be operatively coupled to system bus 502 by the sound adapter 530. A transceiver 595 is operatively coupled to system bus 502 by network adapter 590. A display device 562 is operatively coupled to system bus 502 by display adapter 560.

A first user input device 552, a second user input device 559, and a third user input device 556 are operatively coupled to system bus 502 by user interface adapter 550. The user input devices 552, 559, and 556 can be any of a sensor, a keyboard, a mouse, a keypad, a joystick, an image capture device, a motion sensing device, a power measurement device, a microphone, a device incorporating the functionality of at least two of the preceding devices, and so forth. Of course, other types of input devices can also be used, while maintaining the spirit of the present invention. The user input devices 552, 559, and 556 can be the same type of user input device or different types of user input devices. The user input devices 552, 559, and 556 are used to input and output information to and from system 500.

Deep unsupervised binary coding network (DUBCN) component 570 may be operatively coupled to system bus 502. DUBCN component 570 is configured to perform one or more of the operations described above. DUBCN component 570 can be implemented as a standalone special purpose hardware device, or may be implemented as software stored on a storage device. In the embodiment in which DUBCN component 570 is software-implemented, although shown as a separate component of the computer system 500, DUBCN component 570 can be stored on, e.g., the first storage device 522 and/or the second storage device 529. Alternatively, DUBCN component 570 can be stored on a separate storage device (not shown).

Of course, the computer system 500 may also include other elements (not shown), as readily contemplated by one of skill in the art, as well as omit certain elements. For example, various other input devices and/or output devices can be included in computer system 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the computer system 500 are readily contemplated by one of ordinary skill in the art given the teachings of the present invention provided herein.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for monitoring computing system status by implementing a deep unsupervised binary coding network, comprising:
receiving multivariate time series data from one or more sensors associated with a system;
implementing a long short-term memory (LSTM) encoder-decoder framework to capture temporal information of different time steps within the multivariate time series data and perform binary coding, the LSTM encoder-decoder framework including a temporal encoding mechanism, a clustering loss and an adversarial loss, wherein implementing the LSTM encoder-decoder framework further includes:
generating one or more time series segments based on the multivariate time series data using an LSTM encoder to perform temporal encoding; and
generating binary code for each of the one or more time series segments based on a feature vector;
computing a minimal distance from the binary code to historical data; and
obtaining a status determination of the system based on a similar pattern analysis using the minimal distance.

2. The method as recited in claim 1, wherein the one or more time segments are of a fixed window size.

3. The method as recited in claim 1, wherein the binary code includes hash code.

4. The method as recited in claim 1, wherein the minimal distance is a minimal Hamming distance.

5. The method as recited in claim 1, wherein:
the temporal encoding mechanism encodes temporal order of different ones of the one or more time segments within a mini-batch;
the clustering loss enhances a nonlinear hidden feature structure; and
the adversarial loss enhances a generalization capability of the binary code.

6. The method as recited in claim 5, wherein:
the clustering loss is computed based on soft assignments and an auxiliary target distribution; and
the adversarial loss is computed based on a generator and a discriminator, the generator being configured to generate a sample feature vector based on a concatenation of a clustering membership, the feature vector and a random noise vector, and the discriminator being configured to distinguish between the sample feature vector and the feature vector.

7. The method as recited in claim 1, wherein a full objective of the deep unsupervised binary coding network is computed as a linear combination of the clustering loss, the adversarial loss, and a mean squared error (MSE) loss.

8. A computer program product comprising a non-transitory computer readable storage medium having program instructions embodied therewith, the program instructions executable by a computer to cause the computer to perform a method for monitoring computing system status by implementing a deep unsupervised binary coding network, the method performed by the computer comprising:
receiving multivariate time series data from one or more sensors associated with a system;
implementing a long short-term memory (LSTM) encoder-decoder framework to capture temporal information of different time steps within the multivariate time series data and perform binary coding, the LSTM encoder-decoder framework including a temporal encoding mechanism, a clustering loss and an adversarial loss, wherein implementing the LSTM encoder-decoder framework further includes:
generating one or more time series segments based on the multivariate time series data using an LSTM encoder to perform temporal encoding; and
generating binary code for each of the one or more time series segments based on a feature vector;
computing a minimal distance from the binary code to historical data; and
obtaining a status determination of the system based on a similar pattern analysis using the minimal distance.

9. The computer program product as recited in claim 8, wherein the one or more time segments are of a fixed window size.

10. The computer program product as recited in claim 8, wherein the binary code includes hash code.

11. The computer program product as recited in claim 8, wherein the minimal distance is a minimal Hamming distance.

12. The computer program product as recited in claim 8, wherein:
the temporal encoding mechanism encodes temporal order of different ones of the one or more time segments within a mini-batch;
the clustering loss enhances a nonlinear hidden feature structure; and
the adversarial loss enhances a generalization capability of the binary code.

13. The computer program product as recited in claim 12, wherein:
the clustering loss is computed based on soft assignments and an auxiliary target distribution; and
the adversarial loss is computed based on a generator and a discriminator, the generator being configured to generate a sample feature vector based on a concatenation of a clustering membership, the feature vector and a random noise vector, and the discriminator being configured to distinguish between the sample feature vector and the feature vector.

14. The computer program product as recited in claim 8, wherein a full objective of the deep unsupervised binary coding network is computed as a linear combination of the clustering loss, the adversarial loss, and a mean squared error (MSE) loss.

15. A system for monitoring computing system status by implementing a deep unsupervised binary coding network, comprising:
a memory device storing program code; and
at least one processor device operatively coupled to the memory device and configured to execute program code stored on the memory device to:
receive multivariate time series data from one or more sensors associated with a system;
implement a long short-term memory (LSTM) encoder-decoder framework to capture temporal information of different time steps within the multivariate time series data and perform binary coding, the LSTM encoder-decoder framework including a temporal encoding mechanism, a clustering loss and an adversarial loss, wherein the at least one processing device is further configured to implement the LSTM encoder-decoder framework by:
generating one or more time series segments based on the multivariate time series data using an LSTM encoder to perform temporal encoding; and
generating binary code for each of the one or more time series segments based on a feature vector;
compute a minimal distance from the binary code to historical data; and
obtain a status determination of the system based on a similar pattern analysis using the minimal distance.

16. The system as recited in claim 15, wherein the one or more time segments are of a fixed window size.

17. The system as recited in claim 15, wherein the binary code includes hash code, and wherein the minimal distance is a minimal Hamming distance.

18. The system as recited in claim 15, wherein:
the temporal encoding mechanism encodes temporal order of different ones of the one or more time segments within a mini-batch;
the clustering loss enhances a nonlinear hidden feature structure; and
the adversarial loss enhances a generalization capability of the binary code.

19. The system as recited in claim 18, wherein:
the clustering loss is computed based on soft assignments and an auxiliary target distribution; and
the adversarial loss is computed based on a generator and a discriminator, the generator being configured to generate a sample feature vector based on a concatenation of a clustering membership, the feature vector and a random noise vector, and the discriminator being configured to distinguish between the sample feature vector and the feature vector.

20. The system as recited in claim 15 wherein a full objective of the deep unsupervised binary coding network is computed as a linear combination of the clustering loss, the adversarial loss, and a mean squared error (MSE) loss.
